(19) United States
(12) Patent Application Publication
(10) Pub. No.: US 2019/0240627 A1
(43) Pub. Date: Aug. 8, 2019

(54) DEVICE AND PROCESS FOR PRODUCING AN AQUEOUS SOLUTION OF UREA

(71) Applicant: TOTAL MARKETING SERVICES, PUTEAUX (FR)

(72) Inventors: Christophe GAUTIER, ARGENTON (FR); José URIBESALGO, SAINTE BAZELLE (FR)

(21) Appl. No.: 16/315,822

(22) PCT Filed: Jul. 3, 2017
(86) PCT No.: PCT/EP2017/066491

§ 371 Date: Jan. 7, 2019

(30) Foreign Application Priority Data
Jul. 8, 2016 (FR) 1656580

(51) Int. Cl. B01F 1/00; B01F 5/10; B01F 5/02; B01F 15/02

(52) U.S. Cl. CPC B01F 1/0038; B01F 1/0033; B01F 5/106; B01F 2215/0036; B01F 15/0206; B01F 15/0234; B01F 5/0206

(57) ABSTRACT

A production device includes: at least one device for dissolving solid urea in demineralized water, including a tank for receiving the solid urea and the demineralized water and an outlet for recovering the aqueous solution of urea; a solid urea storage station; and a device for transporting the solid urea from the storage station to the dissolving device, the transporting device being arranged in order to pour solid urea into the tank of the dissolving device. The dissolving device includes at least one nozzle for injecting demineralized water into the solid urea, arranged in the vicinity of the bottom of the tank in order to create water turbulence below the surface of the solid urea and to dissolve the solid urea in the demineralized water.

The present invention relates to a device for producing an aqueous solution of urea from solid urea and demineralized water, of the type comprising:
at least one device for dissolving solid urea in demineralized water, in which the solid urea is dissolved in the demineralized water in order to form an aqueous solution of urea, said dissolving device comprising a tank for receiving solid urea and demineralized water and an outlet for recovering the aqueous solution of urea,
a solid urea storage station,
a device for transporting solid urea from the storage station to the dissolving device, said transporting device being arranged to pour solid urea into the tank of the dissolving device.

The present invention also relates to a process for producing an aqueous solution of urea using such a production device.

In a known manner, such an aqueous solution of urea is used in the selective catalytic reduction process making it possible to convert the majority of the nitrogen oxides (Nox) contained in the exhaust gases into nitrogen and steam.

Such an aqueous solution of urea can also be used in the Nox reduction process by direct injection into the combustion fumes of industrial facilities.

The aqueous solution of urea is obtained by dilution of concentrated liquid urea or by dissolution of solid urea in demineralized water.

In the case of a dilution of liquid urea, the mixture with demineralized water is done on the production site of the urea in order to avoid any transport of concentrated liquid urea. Such a production process is restrictive, since it must be done on the urea production site.

When solid urea is dissolved in the demineralized water, the production of the aqueous solution can be done on a site other than the urea production site, since the transport of solid urea is less restrictive and less expensive than transporting liquid urea. In this case, the solid urea is poured into a mixer containing demineralized hot water and the mixer is actuated to mix the urea and the water until the solid urea is dissolved in the demineralized water. Such a method is not, however, satisfactory. Indeed, manual operations are necessary during the introduction of the urea into the mixer. Furthermore, to guarantee the production of a satisfactory volume of aqueous solution of urea, the mixer has a large bulk to guarantee good mixing of the products in the mixer. The dimensions of the mixing member, formed by rotatable mixing blades, must indeed be sufficient to guarantee the stirring and the mixing of the entire volume of liquid and solid introduced into the mixer. Furthermore, the actuating means of the mixing member further increase the bulk of the production device.

Such production devices are therefore not satisfactory, since they are too bulky and have low productivity levels.

One aim of the invention is to offset the above drawbacks by proposing a device for producing an aqueous solution of urea that is safe, compact and has an improved productivity.

To that end, the invention relates to a device for producing an aqueous solution of urea of the aforementioned type, wherein the dissolving device comprises at least one nozzle for injecting demineralized water into the solid urea poured into the tank, said nozzle for injecting demineralized water being arranged in the vicinity of the bottom of the tank in order to create water turbulence below the surface of the solid urea poured into the tank and to dissolve the solid urea in the demineralized water so as to form the aqueous solution of urea.

The production device according to the invention makes it possible to avoid the manual operations to handle the solid urea during the filling of the tank owing to the transport device able to pour the content of a container of solid urea into the tank. Furthermore, the bulk of the device can be reduced, since it is the injection of water that is arranged to guarantee the dissolution of the solid urea in the demineralized water, which makes it possible to do without a cumbersome mixing member and means for actuating said mixing member. Furthermore, the positioning of the nozzle near the bottom of the tank below the pile of urea poured into the tank makes it possible to avoid any release of steam or splashing outside the tank during the injection of water in the tank and any release of urea dust during the pouring of the urea in the tank.

According to other features of the production device according to the invention, considered alone or according to any technically possible combination:
the production device comprises at least two dissolving devices, the transport device being arranged to pour, consecutively, solid urea into the tank of one of the dissolving devices, then into the tank of the other dissolving device;
the production device comprises three dissolving devices, the transport device being arranged to pour, consecutively, solid urea into the tanks of said dissolving devices;
the dissolving device comprises at least one nozzle for recirculating liquid in the tank, said recirculating nozzle being arranged to homogenize the aqueous solution of urea in the tank;
the storage station is arranged to store containers of urea clumps, the transport device comprising an element for gripping a container and at least one rail on which the gripping element moves in order to move the container to the tank of a dissolving device, said dissolving device comprising a unit for opening the container;
the containers of urea clumps are formed by bags, the gripping element and the rail being arranged to bring the container above the tank of the dissolving device, the opening unit comprising at least one diamond tip equipped with cutting scissors extending in line with the tank and being arranged to tear the bottom of the container such that the urea clumps are poured into the tank under the effect of gravity when the bottom of the container has been torn;
the production device comprises a station for recovering containers after they have been emptied, the gripping element and the rail being arranged to bring the container to said recovery station once the solid urea has been poured from said container into a tank;
a tray for receiving solid urea is partially submerged in the tank, at least the submerged part of the tray forming a basket in fluid communication with the inner volume of the tank such that the urea contained in the tray is bathed in the demineralized water in the tank; and
the tank comprises a filtering element through which the solid urea is poured into the tank, said filtering element being arranged to retain clumps of solid urea with an average diameter larger than a predetermined average diameter.

The invention also relates to a process for producing an aqueous solution of urea from solid urea and demineralized water using a production device as described above, comprising the following steps:
transporting solid urea from the storage station to the tank of a dissolving device and pouring the solid urea into said tank using the transport device so as to form a pile of solid urea in said tank,
injecting demineralized water into the tank below the pile of solid urea so as to dissolve the urea in the demineralized water and form the aqueous solution of urea in the tank,
recovering the aqueous solution of urea from the tank.

According to other features of the production process:
the demineralized water is injected at a temperature substantially between 30° C. and 50° C. into the tank; and
the transport device transports and pours solid urea into the tank of one of the dissolving devices, then into the tank of another dissolving device, the injection of demineralized water into said tanks beginning once a pile of solid urea is formed in said tanks such that the beginning of the dissolving in a dissolving device is offset in time relative to the beginning of the dissolving in another dissolving device.

Other aspects and advantages of the invention will appear upon reading the following description, provided as an example and done in reference to the appended drawings, in which:

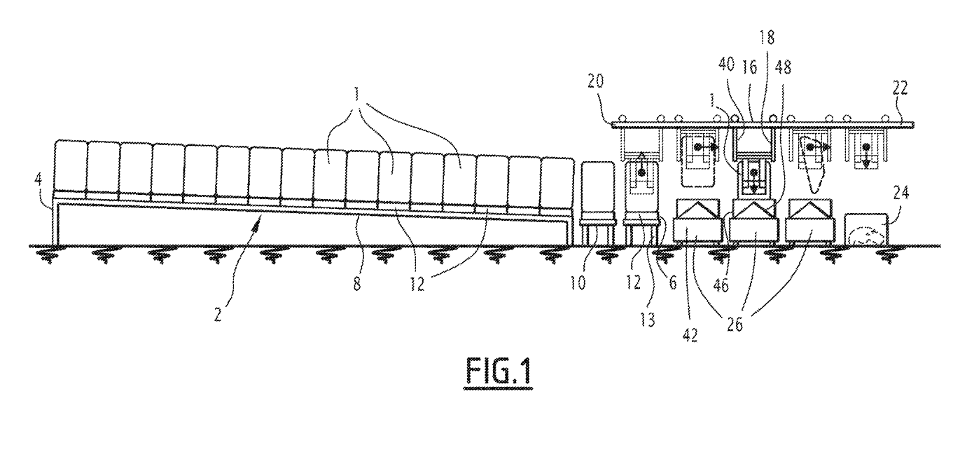

FIG. 1 is a schematic illustration of a device for producing an aqueous solution of urea according to the invention,

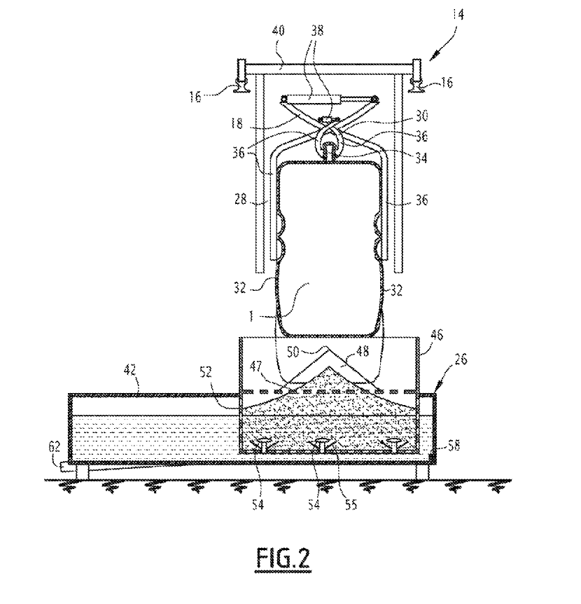

FIG. 2 is a schematic side illustration of part of the production device of FIG. 1,

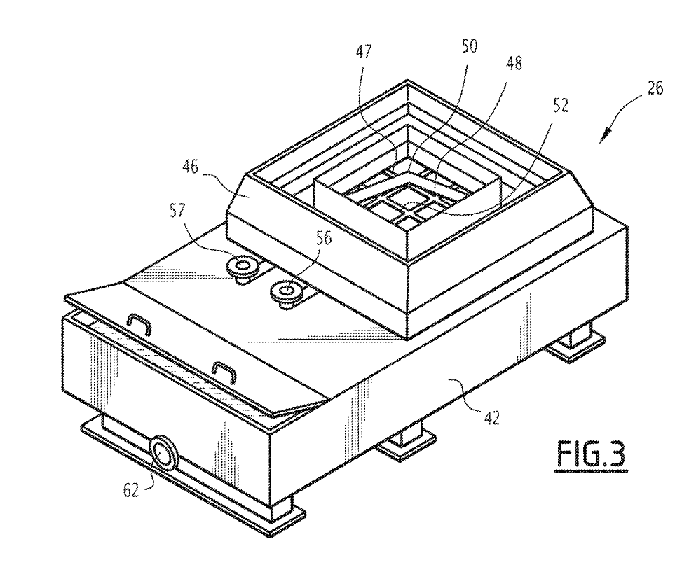

FIG. 3 is a schematic perspective illustration of a dissolving device of the production device of FIG. 1,

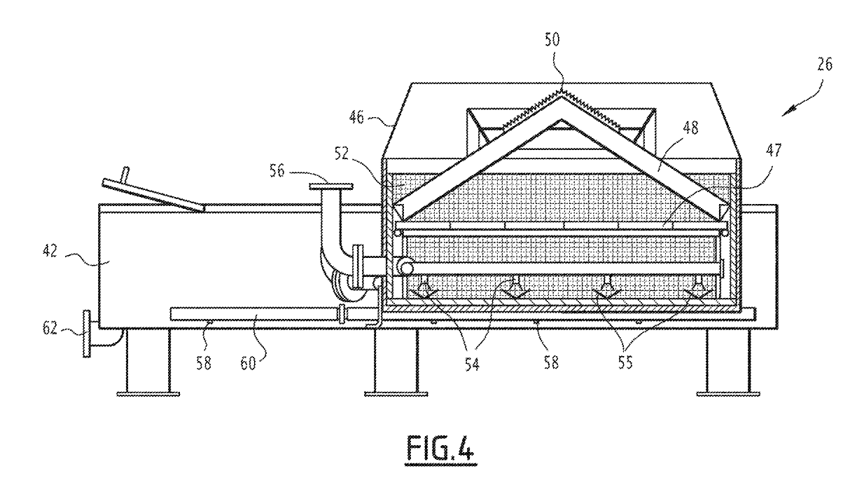

FIG. 4 is a schematic sectional illustration along axis IV-IV of FIG. 3, and

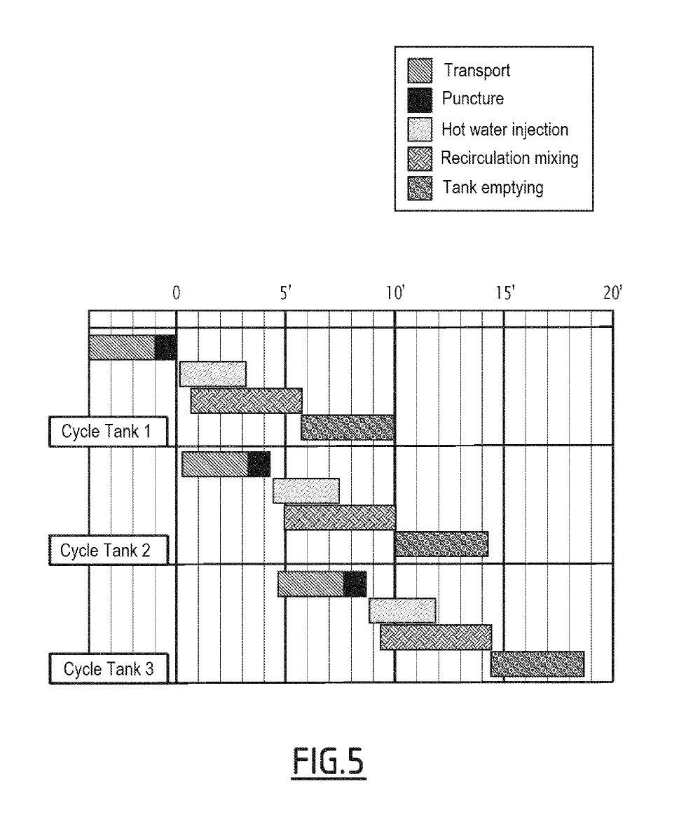

FIG. 5 is a graph showing the production cycles of the aqueous solution of urea by the production device according to the invention.

In reference to FIG. 1, a device is described for producing an aqueous solution of urea from solid urea and demineralized water. Such an aqueous solution of urea forms a diesel exhaust fluid (DEF) making it possible to convert the majority of the nitrogen oxides contained in the exhaust gases into nitrogen and steam. The concentration of urea in aqueous solution is substantially equal to 32.5% and satisfies standard ISO22241.

The solid urea is for example provided in the form of clumps of solid urea. The clumps for example assume the form of beads. The clumps are for example transport containers 1. The containers are for example bags of the “big bag” type with a content substantially equal to 1.5 m³, corresponding to a ton of solid urea. Such bags are sealably closed such that the solid urea is not in contact with the environment and operators handling the bags do not touch the solid urea contained in the bags. The beads for example have an average diameter of between 1 mm and 3 mm. Alternatively, the solid urea could be provided in powder form.

The production device comprises a storage station 2 for the containers 1. The storage station 2 extends between an inlet 4 at which the containers 1 are introduced into the storage station 2 and an outlet 6 at which the containers are removed from the storage station 2 to be emptied, as will be described later. Between the inlet 4 and the outlet 6, the storage station 2 for example comprises a tilted ramp 8 allowing the containers to slide toward the outlet under the effect of gravity. At the outlet, the storage station 2 comprises a transfer table 10 intended to receive the container 1 about to be removed from the storage station 2. The containers 1 are for example transported on pallets 12 arranged to move over the tilted ramp 8. In this case, the storage station 2 comprises, downstream from the transfer table 10, a depalletizer 13 arranged to separate the container 1 from the pallet 12 on which it is deposited.

According to one embodiment, the storage station 2 may comprise several parallel ramps.

At the outlet of the storage station 2, a container 1 is placed on the transfer table 10 and is positioned on the table of the depalletizer 13, to be picked up by a transport device 14 allowing the transport of a container 1. The transport device 14 comprises at least one rail 16 on which a gripping element 18 is translatable.

The rail 16 extends along an upstream-downstream direction between an upstream end 20 extending above the outlet 6 of the storage station 2 and a downstream end 22 extending above a recovery station 24 for empty containers 1, described later. Between the upstream end 20 and the downstream end 22, the rail 16 extends above one or several production devices 26 for the aqueous solution of urea, as will be described later. According to the embodiment shown in FIG. 2, the transport device 14 comprises two rails 16 parallel to one another and supporting the gripping element 18 between them.

According to the embodiment shown in FIG. 2, the gripping element 18 is formed by a main clamp 28 and by a secondary clamp 30. The main clamp 28 is arranged to grasp a filled container 1 by its side walls 32 and makes it possible to transport said container 1 along the rail. The secondary clamp 30 is arranged to grasp a container 1 by its upper end part 34, which for example forms a knot when the container 1 is closed. Thus, the main clamp 28 makes it possible to transport the container when it is full, while the secondary clamp 30 makes it possible to transport the container when it is empty, as will be described later. The main 28 and secondary 30 clamps each comprise two jaws 36 that are movable relative to one another between a closed position and a separated position making it possible to adjust the separation of the clamps. The actuation of the clamps is for example done by jacks 38 provided at one end of the jaws 36, as shown in FIG. 2.

The gripping element 18, in addition to being translated along the rail(s) 16, is also translatable relative to the rail(s) 16 along an elevation direction substantially perpendicular to the upstream-downstream direction. This movement makes it possible to vary the distance between the gripping element 18 and the stations and devices above which the gripping element 18 moves. To that end, the gripping element for example comprises a carriage 40 translatable along the upstream-downstream direction over the rail(s) 16, the main 28 and secondary 30 clamps being mounted translatable along the elevation direction on the carriage 40.

We will now describe a device 26 for dissolving the solid urea in the demineralized water.

The dissolving device 26 comprises a tank 42 suitable for receiving the solid urea contained in a container 1. More particularly, the solid urea is received in a tray 46 partially submerged in the tank 42. The tank 42 has a liquid content capacity for example between 3.0 m³ and 3.4 m³, which allows the tank 42 to contain all of the aqueous solution of urea produced from the solid urea contained in a container 1 as described above.

An opening unit 48 of the container 1 extends substantially at the center of the upper part of the tray 46 in order to allow the opening of the bag when it is introduced into the upper part of the tray 46. The opening unit 48 for example comprises a diamond tip 50 equipped with cutting knives arranged to tear the bottom of the container 1 and thus to release the urea contained in the container 1, which can be poured into the bottom of the tray 46 by gravity.

Below the opening unit 48, a filtering element 47 is provided through the tray 46 in order to filter the solid urea being poured into the tray 46. More particularly, the filtering element 47, for example a grating or a screen, makes it possible to prevent overly large clumps of urea from falling into the tray 46, which would risk damaging the nozzles for injecting demineralized water, which will be described later. To that end, the filtering element 47 comprises openings suitable for allowing the clumps of urea with an average diameter smaller than a predetermined average diameter to pass and for preventing the passage of clumps with an average diameter larger than the predetermined average diameter. The predetermined average diameter is for example substantially equal to 3 mm. The filtering element 47 also makes it possible to prevent the passage of pieces of the container 1, these pieces being able to detach from the container 1 when the opening element 48 has torn the bottom of the container 1.

At least the submerged part of the tray 46 is formed by a basket 52, for example made from perforated sheets, i.e., provided with a plurality of openings allowing the fluid communication between the content of the basket and the inner volume of the tank 42. The volume occupied by the basket 52 in the inner volume of the tank 42 is for example between 1.5 m³ and 2 m³, for example equal to 1.7 m³. According to one embodiment, the tray 46 is formed by an upper part protruding from the tank 42 and the walls of which are closed to prevent any solid urea from escaping outside the tank, and a lower part extending in the inner volume of the tank 42 and formed by a basket 52 as described above.

The dissolving device 26 further comprises at least one nozzle 54 for injecting water into the inner volume of the basket 52. The injection nozzle 54 makes it possible to inject water into the inner volume of the basket 52 in order to dissolve the pile of solid urea formed during the opening of the container 1. The injection nozzle 54 is connected by an inlet 56 to a water source and means for heating the water. The water is demineralized water, for example water treated by reverse osmosis heated to a temperature of between 30° C. and 50° C., generally close to 45° C.

According to the embodiment shown in FIGS. 2 and 4, the injection nozzle 54 is located at the bottom of the basket 52, near the bottom of the tank 42. Such an arrangement in which the injection nozzle 54 injects the water into the pile of urea arranged in the tray 46 makes it possible to create water turbulence below the surface of the solid urea in order to dissolve the solid urea in the demineralized water.

The injection nozzle 54 for example comprises an outlet oriented toward the bottom of the tank 42 and through which the water is injected and a deflector 55 extending across from the outlet and oriented at 45° toward the top of the tray 46, i.e., toward the upper part of the tray 46, in order to reorient the injected water toward the pile of urea in the basket 52. Such an arrangement makes it possible to protect the nozzle 54 when the urea is poured into the tray 46 and to prevent the outlet of the nozzle from being able to become plugged by urea.

According to one embodiment, several injection nozzles 54 are distributed at the bottom of the basket 52 so as to inject hot water below all of the piles of solid urea and thus to make it possible to dissolve the base of the pile of urea uniformly that is located opposite the bottom of the basket 52. According to one embodiment, sixteen injection nozzles 54 forming rows and columns of four nozzles at the bottom of the basket 52 are provided. Each injection nozzle 54 for example has a flow rate of substantially between 2 m³/hour and 3 m³/hour such that 2.1 m³ of water can be injected into the tank 42 in 3 minutes. The formed solution of urea and demineralized water flows through the perforations of the basket 52 into the tank 42.

According to one embodiment, the dissolving device 26 further comprises at least one recirculation nozzle 58 provided in the tank 42 and arranged to homogenize the liquid present in the tank 42. More particularly, as shown in FIG. 4, the dissolving device 26 for example comprises a recirculation circuit 60 formed by a pipe provided with recirculation nozzles 58 and connected to an inlet 57. The pipe is arranged along the bottom of the nozzle 42 and makes it possible to create a liquid circulation flow in the tank so that the liquid in the tank is mixed. The dissolving device 26 lastly comprises a liquid outlet 62 arranged at the bottom and at one end of the tank 42. The outlet 62 is connected to a pump (not shown) that makes it possible either to supply the inlet 57 to perform the recirculation, or to empty the tank 42 into a storage tank (not shown) for the aqueous solution of urea produced in the dissolving device 26. The recirculation pump for example has a flow rate substantially equal to 40 m³/h.

The dissolving device 26 described above makes it possible to produce, from a container of 1 T of solid urea and 2.1 m³ of water treated by reverse osmosis heated to a temperature of between 30° C. and 50° C., generally close to 45° C., 2.85 m³ of aqueous solution of urea concentrated in urea at 32.5%. Indeed, obtaining 1 m³ of aqueous solution of urea concentrated in urea at 32.5% requires mixing 0.736 m³ of water at 45° C. and 0.354 T of urea. Between transporting the container of urea 1 and emptying the obtained aqueous solution, approximately fifteen minutes have elapsed, as will be described later. Such a dissolving device makes it possible to produce an aqueous solution of urea satisfying standard ISO22241 using a single step for depositing all of the solid urea contained in a container. The bulk of the dissolving device can be reduced, since the volume of the tank can be adjusted to the quantity of water necessary to dissolve all of the solid urea contained in a container 1 to produce the aqueous solution of urea to the desired concentration without requiring a mobile mixing element, of the rotary mixer type. Thus, the dissolving device does not require means for actuating such a movable mixing element outside the tank.

The production of an aqueous solution of urea can be optimized by providing several dissolving devices 26 as described above. Thus, two dissolving devices 26 can be used. This makes it possible to use the transport device 14 to bring a container 1 toward the second dissolving device 26 while the dissolving of the solid urea derived from a first container takes place in the first dissolving device. The production process is, however, particularly improved by using three dissolving devices 26, as shown in FIG. 1. In this case, the three dissolving devices 26 are arranged next to one another along the upstream-downstream device below the transport device 14, as shown in FIG. 1.

A process for producing an aqueous solution of urea using a production device comprising three dissolving devices 26 will now be described in more detail.

The storage station 2 is provided with containers 1, at least [sic] of which is located at the outlet 6 of the storage station 2, either on the table 10, or on the depalletizer 13. The gripping element 18 of the transport device 14 is positioned above the outlet 5 and is lowered with the main 28 and secondary 30 clamps in the open position. When the main clamp 28 is brought around the side walls 32 of the container 1, the secondary clamp 30 is located across from the loop 34 formed at the upper end of the container 1. The main 28 and secondary 30 clamps are then placed in the closed position and the gripping element 18 is raised to lift the container 1.

The gripping element 18 then moves along the rail(s) 16 until it is located above the inlet casing 46 of the first dissolving device 26. The gripping element 18 is then lowered again to cause the bottom of the container 1 to penetrate the tray 46. The bottom of the container 1 is torn by the opening device 48 such that the solid urea is emptied and forms a pile in the basket 52 while passing through the filtering element 47 of the tank 42. The upper part of the tray 46 makes it possible to prevent solid urea from being poured outside the dissolving device 26. When the container 1 has been emptied, the gripping element 18 is raised while the container 1 is still held by the secondary clamp 30. The gripping element 18 transporting the empty container 1 is then moved along the rail(s) 16 until it is located above the recovery station 24. The secondary clamp 30 is then opened and the empty container 1 is released into the recovery station 24.

The gripping element 18 is brought back to the outlet 6 of the storage station 2, where it grasps a new container 1 and brings it to the second dissolving device 26. The operations described above are repeated by the gripping element 18, then the gripping element restarts the operations for the third dissolving device 26.

The step for transporting a container above a dissolving device 26, shown crosshatched in FIG. 5, takes about three minutes. The step for puncturing the container 1 and pouring solid urea into the tub 46, shown in black in FIG. 5, takes about one minute. The gripping element 18 is next brought to the recovery station 24, then to the outlet 6 of the storage station 2, where it is again available to perform a new transport step to another dissolving device 26.

For each dissolving device 26, once the latter receives a pile of solid urea, the injection of demineralized water heated to a temperature of substantially between 30° C. and 50° C., for example a temperature close to 45° C., in the tank 42 begins. This step, shown in dots in FIG. 5, lasts about 3 minutes, at the end of which about 2.1 m³ of water has been injected into the tank 42.

Once the first m³ of water has been injected into the tank 42, the recirculation nozzle(s) 58 are started in order to homogenize the mixture of water and urea in the tank. This step, as shown in FIG. 5, begins within the minute following the beginning of the step for injecting water and lasts about 5 minutes.

At the end of this step, the solid urea contained in the container 1 has been completely dissolved in the water and the tank 42 contains the desired aqueous solution of urea. The emptying of the tank through the outlet 62 can then begin in order to transfer the aqueous solution of urea to the storage tank. As shown in FIG. 5, the emptying of the tank 42 lasts about 4 minutes and 30 seconds. During the transfer of the aqueous solution of urea from the tank 42 of a dissolving device 26 to the storage tank, a mass densimeter can be provided to save the characteristics of the obtained aqueous solution of urea, for example its urea concentration.

Each dissolving device 26 works with a shift of 4 minutes with the dissolving device 26 preceding it or following it. Thus, the dissolving step in the second dissolving device 26 begins four minutes after that in the first dissolving device 26 and four minutes before that in the third dissolving device 26. When the first dissolving device 26 receives the solid urea from a container, the recirculation step occurs in the second dissolving device 26 and the emptying of the tank 42 of the third dissolving device 26 takes place.

Such a production device and process make it possible to produce an aqueous solution of urea meeting the requirements of standard ISO22241 while optimizing the use of available water resources (tank of 140 m³ of cold demineralized water and 6 m³ of heated water), the flow rates imposed by the emptying pumps of the tanks 42 (about 40 m³/h) and the number of storage tanks of aqueous solution of urea (for example, three tanks of 140 m³) of a production site of the aqueous solution of urea. Furthermore, as previously indicated, the bulk of the production device is reduced owing to the use of the dissolving devices 26.

The volume, weight, flow rate, etc. values have been given solely as an example and may vary depending on the production sites. In particular, the volume of the tank of a dissolving device may vary depending on the quantity of solid urea contained in the containers 1.

1. A device for producing an aqueous solution of urea from solid urea and demineralized water, of the type comprising:
at least one device (26) for dissolving solid urea in demineralized water, in which the solid urea is dissolved in the demineralized water in order to form an aqueous solution of urea, said dissolving device (26) comprising a tank (42) for receiving solid urea and demineralized water and an outlet (62) for recovering the aqueous solution of urea,
a solid urea (2) storage station,
a device (14) for transporting solid urea from the storage station (2) to the dissolving device (26), said transporting device (14) being arranged to pour solid urea into the tank (42) of the dissolving device (26),
wherein the dissolving device (26) comprises at least one nozzle (54) for injecting demineralized water into the solid urea poured into the tank (42), said nozzle (54) for injecting demineralized water being connected to a demineralized water source and being arranged in the vicinity of the bottom of the tank (42) in order to create water turbulence below the surface of the solid urea poured into the tank (42) and to dissolve the solid urea in the demineralized water so as to form the aqueous solution of urea.

2. The production device according to claim 1, comprising at least two dissolving devices (26), the transport device (14) being arranged to pour, consecutively, solid urea into the tank (42) of one of the dissolving devices (26), then into the tank (42) of the other dissolving device (26).

3. The production device according to claim 2, comprising three dissolving devices (26), the transport device (14) being arranged to pour, consecutively, solid urea into the tanks (46) of said dissolving devices (26).

4. The production device according to claim 1, wherein the dissolving device (26) comprises at least one nozzle (58) for recirculating liquid in the tank (42), said recirculating nozzle (58) being arranged to homogenize the aqueous solution of urea in the tank (42).

5. The production device according to claim 1, wherein the storage station (2) is arranged to store containers (1) of urea clumps, the transport device (14) comprising an element (18) for gripping a container (1) and at least one rail (16) on which the gripping element (18) moves in order to move the container (1) to the tank (42) of a dissolving device (26), said dissolving device (26) comprising a unit (48) for opening the container (1).

6. The production device (6) according to claim 5, wherein the containers (1) of urea clumps are formed by bags, the gripping element (18) and the rail (16) being arranged to bring the container (1) above the tank (42) of the dissolving device (26), the opening unit (48) comprising at least one diamond tip (50) equipped with cutting scissors extending in line with the tank (42) and being arranged to tear the bottom of the container (1) such that the urea clumps are poured into the tank (42) under the effect of gravity when the bottom of the container (1) has been torn.

7. The production device according to claim 6, comprising a station (24) for recovering containers (1) after they have been emptied, the gripping element (18) and the rail (16) being arranged to bring the container (1) to said recovery station once the solid urea has been poured from said container (1) into a tank (42).

8. The production device according to claim 1, wherein a tray (46) for receiving solid urea is partially submerged in the tank (42), at least the submerged part of the tray (46) forming a basket (52) in fluid communication with the inner volume of the tank (42) such that the urea contained in the tray (46) is bathed in the demineralized water in the tank (42).

9. The production device according to claim 1, wherein the tank (42) comprises a filtering element (47) through which the solid urea is poured into the tank (42), said filtering element (47) being arranged to retain clumps of solid urea with an average diameter larger than a predetermined average diameter.

10. A process for producing an aqueous solution of urea from solid urea and demineralized water using a production device according to claim 2, comprising the following steps:
transporting solid urea from the storage station (2) to the tank (42) of a dissolving device (26) and pouring the solid urea into said tank (42) using the transport device (14) so as to form a pile of solid urea in said tank (42),
injecting demineralized water into the tank (42) below the pile of solid urea so as to dissolve the urea in the demineralized water and form the aqueous solution of urea in the tank (42),
recovering the aqueous solution of urea from the tank (42).

11. The production process according to claim 10, wherein the demineralized water is injected at a temperature substantially between 30° C. and 50° C. into the tank (42).

12. The production process according to claim 10, wherein the transport device (14) transports and pours solid urea into the tank (42) of one of the dissolving devices (26), then into the tank (42) of another dissolving device (26), the injection of demineralized water into said tanks (42) beginning once a pile of solid urea is formed in said tanks (42) such that the beginning of the dissolving in a dissolving device (26) is offset in time relative to the beginning of the dissolving in another dissolving device (26).

13. The production device according to claim 2, wherein the dissolving device comprises at least one nozzle for recirculating liquid in the tank, said recirculating nozzle being arranged to homogenize the aqueous solution of urea in the tank.

14. The production device according to claim 3, wherein the dissolving device comprises at least one nozzle for recirculating liquid in the tank, said recirculating nozzle being arranged to homogenize the aqueous solution of urea in the tank.

15. The production device according to claim 2, wherein the storage station is arranged to store containers of urea clumps, the transport device comprising an element for gripping a container and at least one rail on which the gripping element moves in order to move the container to the tank of a dissolving device, said dissolving device comprising a unit for opening the container.

16. The production device according to claim 3, wherein the storage station is arranged to store containers of urea clumps, the transport device comprising an element for gripping a container and at least one rail on which the gripping element moves in order to move the container to the tank of a dissolving device, said dissolving device comprising a unit for opening the container.

17. The production device according to claim 4, wherein the storage station is arranged to store containers of urea clumps, the transport device comprising an element for gripping a container and at least one rail on which the gripping element moves in order to move the container to the tank of a dissolving device, said dissolving device comprising a unit for opening the container.

18. The production device according to claim 2, wherein a tray for receiving solid urea is partially submerged in the tank, at least the submerged part of the tray forming a basket in fluid communication with the inner volume of the tank such that the urea contained in the tray is bathed in the demineralized water in the tank.

19. The production device according to claim 3, wherein a tray for receiving solid urea is partially submerged in the tank, at least the submerged part of the tray forming a basket in fluid communication with the inner volume of the tank such that the urea contained in the tray is bathed in the demineralized water in the tank.

20. The production device according to claim 4, wherein a tray for receiving solid urea is partially submerged in the tank, at least the submerged part of the tray forming a basket in fluid communication with the inner volume of the tank such that the urea contained in the tray is bathed in the demineralized water in the tank.
